(19) United States
(12) Patent Application Publication
(10) Pub. No.: US 2002/0051252 A1
(43) Pub. Date: May 2, 2002

(54) Method for image positioning of a digital image capturing device

(76) Inventors: Lee-Shan Chang, Chung Li (TW); Yang Ni, Hsinchu (TW); Chun-Hsing Hsieh, Hsinchu (TW)

Correspondence Address: BAKER & BOTTS, 30 ROCKEFELLER PLAZA, NEW YORK, NY, 10112

(21) Appl. No.: 09/877,646

(22) Filed: Jun. 8, 2001

(30) Foreign Application Priority Data
Aug. 25, 2000 (TW) 89117301

(51) Int. Cl. H04N 1/46

(52) U.S. Cl. 358/505

(57) ABSTRACT

The present invention is a fast method for image positioning of an image capturing device. The present invention refers to maintain relative position of each component of an digital image capturing device after assembly rather not to adjust the position of each component, such as, the position of an image sensor, a camera lens and a camera case. The present invention shifts a centerline of an image capturing area of the image sensor from a geometric centerline of the image sensor to an optical-axis centerline of the camera lens that the optical centerline of the image capturing area could be coincident with the optical-axis centerline of the camera lens.

### FIELD OF THE INVENTION

This invention relates to a method for image positioning of a digital image capturing device, and specifically relates to a fast method for positioning centerlines of a camera lens and of an image sensor.

### BACKGROUND OF THE INVENTION

The operating principle of a digital image capturing device resembles a traditional image capturing device. Both of them use an optical camera lens to focus light, reflected from objects, into the image capturing device. The only difference between them is the sensor. The traditional image capturing device utilizes sensitizer coating on a film to sense lights and then records the image on the film. However, the digital image capturing device utilizes a charge coupled device (CCD) or a complementary metal-oxide semiconductor (CMOS) as an image sensor to transform light, reflected from objects, into digital signals and save them in a built-in RAM or a portable PC card.

The geometric centerline of an image sensor inside a typical digital image capturing device is the optical centerline of an image capturing area. During the manufacturing of digital image capturing devices, the assembly error will result from the assembling process of components, such as image sensors, camera lenses, and camera cases. This error will result in an oblique view angle of a digital image capturing device. As shown in FIG. 1A, since the geometric centerline 120, of the image capturing area inside the image sensor 100 is on the left side of the optical-axis centerline 130, of the camera lens 110, the image sensor 100 senses the object 140 on the right side of the camera lens 110. As shown in FIG. 1B, since the geometric centerline 120, of the image capturing area inside the image sensor 100, is on the right side of the optical-axis centerline 130, of the camera lens 110, the image sensor 100 senses the object 140 on the left side of the camera lens 110.

Traditionally, the manufacturing method of image capturing devices is to adjust the relative position of each component of the devices, e.g., changing the relative positions of the camera lens 110 and the camera case, or changing the position of the image sensor 100 on the printed circuit board (PCB). As a result, the optical-axis centerline 130, of the camera lens 110, and the image center (not shown) of the image sensor 100 could coincide together. And the light, reflected from object 140 in front of camera lens 110, could focus on the central area of the image sensor 100. An image could therefore be sensitized and generated. As shown in FIG. 1C, the geometric centerline of the capturing image area inside image sensor 100 is coincided with optical-axis centerline 130, and image sensor 100 could sense object 140 in front of camera lens 110. However, there are some drawbacks in the traditional mechanical adjustment described above. For example, the precision of mechanical adjustment for relative positions of each traditional camera's components is limited. In addition, the unit distance for adjustment is based on pixels and such little adjustment for image positioning is very difficult. Moreover, it also takes a lot of time and money for the manufacturing of the digital image capturing device.

Accordingly, it is crucial to improve the traditional method of image positioning for an image capturing device.

### SUMMARY OF THE INVENTION

It is an objective of this invention to provide a method to improve the image positioning of an image capturing device. The method refers to maintain their original relative positions after components have been assembled, rather than to adjust relative positions of each component of an image capturing device.

The invention for image positioning is to utilize a specific diagram with a marked point to find out the positioning relationship between the optical centerline and the geometric centerline of an image capturing device. Then the positioning relationship is used to shift the centerline of an image sensor's image capturing area from the geometric centerline of the image sensor to the optical-axis centerline of the camera lens to coincide together. Accordingly, the object images, captured by the image sensor, are the object images in front of the camera lens.

### BRIEF DESCRIPTION OF THE DRAWINGS

FIG. 1A schematically illustrates a top view of an image sensor sensoring its right-side object.

FIG. 1B schematically illustrates a top view of an image sensor sensoring its left-side object.

FIG. 1C schematically illustrates a top view of an image sensor sensoring an object in front of it.

FIG. 2 schematically illustrates a front view of the first image capturing area of an image sensor for the present invention.

FIG. 3 schematically illustrates a front view of the first and second image capturing areas of an image sensor for the present invention.

FIG. 4 schematically illustrates a top view of an image sensor and camera lens after image positioning for the present invention.

FIG. 5 schematically illustrates a front view of the first and second reference points of an image display device for the present invention.

### DETAILED DESCRIPTION OF THE PREFERRED EMBODIMENT

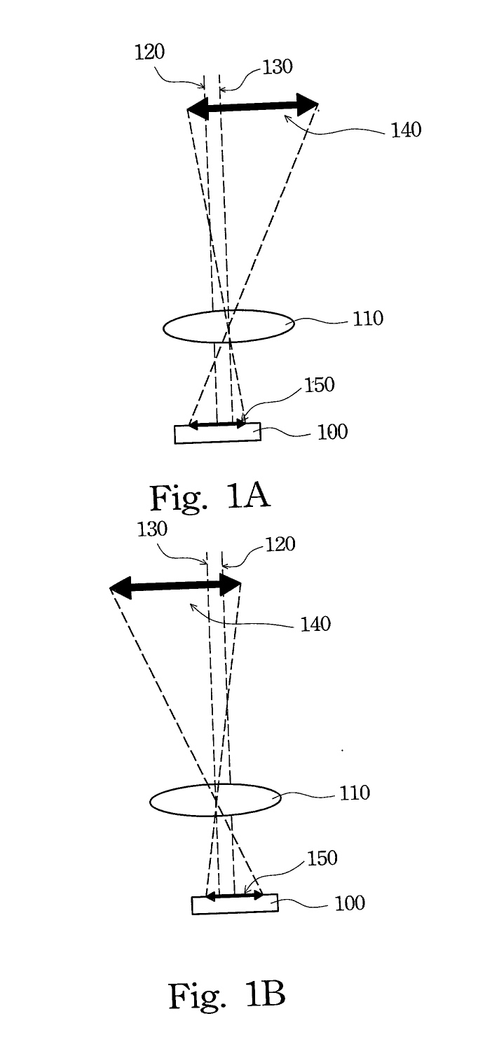

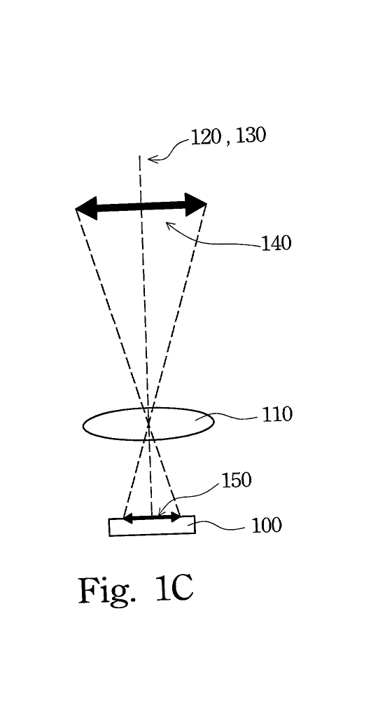

The present invention is essentially a fast method for image positioning of an image capturing device. As illustrated in FIG. 1A-C, the present invention refers to maintain relative position of each component of an digital image capturing device after assembly, rather than to adjust the position of each component, such as the positions of an image sensor 100 of a camera lens 110 and of a camera case (not shown), wherein the image sensor 100 is selected from a charge coupled device (CCD) and a complementary metal-oxide semiconductor. The present invention shifts the centerline of the image capturing area from geometric centerline 120 of image sensor 100 to optical-axis centerline 130 of camera lens 110 so that the optical centerline of the image capturing area coincides with optical-axis centerline 130 of camera lens 110. Accordingly, the present invention enhances of the image positioning of digital image capturing devices, i.e., image sensor 100 could sense image 150 of object 140 in front of camera lens 110.

FIG. 1A-C illustrates image sensor 100 of the image capturing device. Image sensor 100 transforms light reflected from sensoring object 140 into electronic signals via camera lens 110. The processes of image positioning between image sensor 100 and camera lens 110 are described as below.

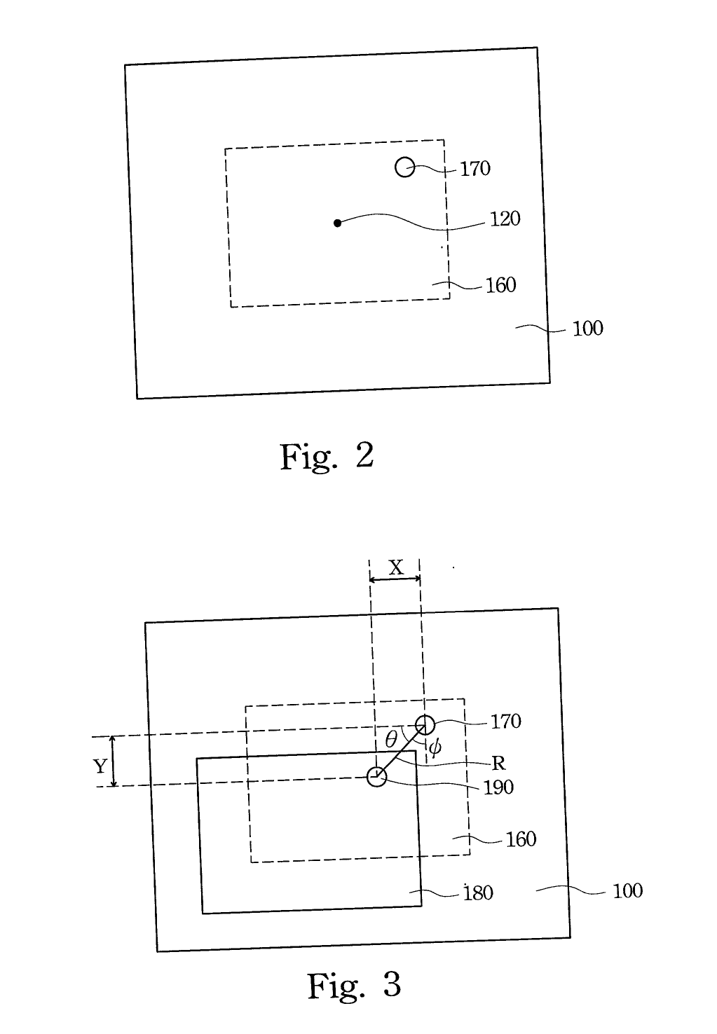

As shown in FIG. 2, a first image capturing area 160 is set on image sensor 100. Geometric centerline 120 (the vertical line pointing image sensor 100) of image sensor 100 inside the image capturing device is set as the optical centerline of the first image capturing area 160. Traditionally, geometric centerline 120 of image sensor 100 is set as the optical centerline of the image capturing area so that it often takes a lot of efforts to adjust the position of the geometric centerline to coincide with the optical centerline of the image capturing area. While according to the present invention, there is no need to adjust the relative position between geometric centerline and the optical centerline.

A first reference point 170 is set at any point in the first image capturing area 160. There exists a specific location relationship between the first reference point 170 and the optical centerline of the first image capturing area 160, such as a specific horizontal and vertical distance, or a specific distance and a specific horizontal or vertical angle.

A specific diagram with a marked point (not shown) is also provided and displayed on image sensor 100. Assume that the image area of the specific diagram displayed on image sensor 100 is the same as the first image capturing area 160. More specifically, the location relationship of marked point on the specific diagram is the same as the location relationship between the first reference point 170 and the first image capturing area 160. In fact, unfortunately, the image area of the specific diagram displayed on image sensor 100 does not always coincide with the first image capturing area 160, because the positions of the optical centerlines of the image capturing area and of the first image capturing area 160 are not the same. As a result, the real image area of the specific diagram displayed on the image sensor 100 is set as the second image capturing area 180, as shown in FIG. 3.

Specifically, the marked point of the specific diagram projected and shown in the second image capturing area 180 is set as the second reference point 190. Accordingly, the location relationship of the second reference point 190 shown in the second image capturing area 180 is the same as the location relationship of the first reference point 170 shown in the first image capturing area 160, i.e., the location relationship between the second reference point 190 and the optical center of the second image capturing area 180 is the same as the location relationship between the first reference point 170 and the optical center of the first image capturing area 160. More specifically, supposed geometric centerline 120 of the image sensor inside the digital image capturing device coincides with optical-axis centerline 130 of camera lens 110, the specific diagram could be just projected within the scope of image capturing area 160. Meanwhile, the second reference point 190, which is projected by the marked point of the specific diagram, shown in the second image capturing area 180 will also coincide the first reference point 170 inside the first image capturing area 160.

In general, due to the assembly error occurred in the process of manufacturing the digital image capturing device, geometric centerline 120 of the image sensor inside the digital image capturing device does not coincide with optical-axis centerline 130 of camera lens 110. Thus, the first reference point 170 does not coincide with the second reference point 190, either. The positioning relationship between the first reference point 170 and the second reference point 190 is recorded. As indicated in FIG. 3, the positioning relationship, between the first reference point 170 and the second reference point 190, relates to the horizontal distance X and the vertical distance Y between these two points, or the distance R and the horizontal angle θ or the vertical angle φ between these two points.

The positioning relationship described above is saved in a recording unit, a controller, a memory, a signal processor, or circuits inside the image capturing device or the like for subsequent processes of image capturing.

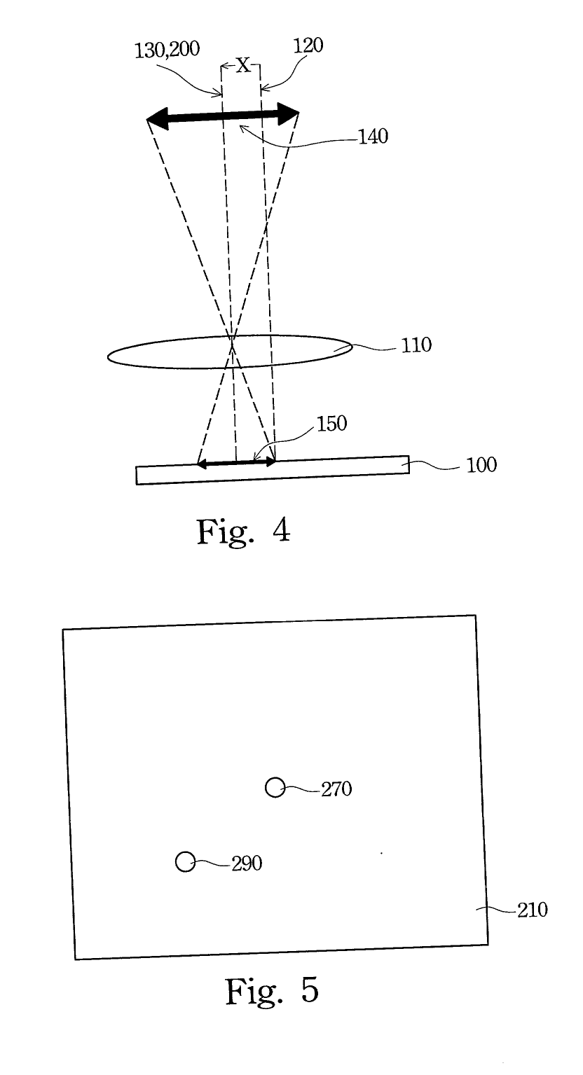

As shown in FIG.4, the positioning relationship described above is utilized to shift the image capturing center of image sensor 100, i.e., to reset the image capturing center of image sensor 100 from the optical center of the first image capturing area 160 (i.e., geometric centerline 120 of image sensor 100) to optical center 200 of the second image capturing area 180 (i.e., the optical centerline of the real image capturing area of image sensor 100). As a result, the image positioning of a digital image capturing device could be achieved according to the present invention described above.

An embodiment of the present invention discloses a method of image positioning via a digital image positioning testing device, which comprises one sensoring unit for sensoring images and generating electronic signals, one signal connection unit coupling with the sensoring unit to transmit the electronic signals, and one image display unit coupling with the signal connection unit to receive electronic signals and to show the image.

As shown in FIG. 5, the first reference point 270 is set on image display unit 210 and is provided a specific diagram with a marked point displayed on image display unit 210 inside the digital image positioning testing device, wherein the marked point just coincides with the first reference point 270 on image display unit 210 via the sensoring unit and signal connection unit. The relative positions between the digital image positioning testing device and the specific diagram is recorded so that the marked point on the specific diagram could always coincide with the position of the first reference point 270 on image display unit 210 inside the digital image positioning testing device.

Referring to FIG. 1-C and FIG. 5, in the process of the image positioning, the digital image capturing device will be installed in the testing device described above. The specific diagram will be projected on image display unit 210 via image sensor 100 of the digital image capturing device, the sensoring unit, and the signal connection unit of the testing device. Supposed each component of the digital image capturing device is assembled accurately (e.g., the image sensor, the camera lens and the case of the camera), then the marked point of the specific diagram could be projected and coincides with the position of the first reference point 270 on image display unit 210. Unfavorably, if the assembly error was formed during the manufacturing and assembling of each component of the digital image capturing device, optical-axis centerline 130 of camera lens 110 would not coincide with geometric centerline 120 of image sensor 100. Accordingly, the marked point of the specific diagram could not be shown on the position of the first reference point 270 on image display unit 210, but shown on the other point on image display unit 210, set this point as the second reference point 290.

The positioning relationship of the first reference point 270 and the second reference point 290 displayed on image display unit 210 is recorded, such as the horizontal distance X and the vertical distance Y between these two points, or the distance R and the horizontal angle θ or the vertical angle φ between these two points, in an image controller, a recording unit, a memory, a signal processor, or circuits inside the image capturing device or the like. This positioning relationship is used to reset the position of the optical center of the image capturing area on image sensor 100. That is, to reset the second reference point 290 as image capturing center of image sensor 100 rather the first reference point 270. Therefore, the optical centerline of the real image capturing area on image sensor 100 does coincide with optical-axis centerline 130 of camera lens 110. As a result, camera lens 110 of the digital image capturing device could sense the object in front of it.

More specially, one preferred embodiment of image positioning according to the present invention is to set one of four corners of image display unit 210 as the origin of an absolute coordinate, and set the first reference point 270 is located at the central point of image display unit 210. Moreover, make sure that the point, projected by the marked point of the specific diagram, coincides with the first reference point 270. Then, the processes left of image positioning of other digital image capturing devices are only to reset the point 290, displayed by the marked point of the specific diagram, as the optical center of the image capturing area of the image sensor inside the digital image capturing device.

In another embodiment of the present invention, a bigger image sensor could be used to sense the whole image of an object. Thus, only one part of the whole image signal could be picked up according to the positioning relationship described above, i.e., the image signals which represent the image of the object in front of the camera lens could be picked up after the positioning relationship of the first reference point 270 and the second reference point 290 was found and saved. For example, as shown in FIG. 3, only the image signals, representing the image of the second image capturing area 180, is picked up according to where the position relationship was found and saved.

Although the invention has been described in detail herein with reference to its preferred embodiment, it is to be understood that this description is by way of example only, and is not to be construed in a limiting sense. It is to be further understood that numerous changes in the details of the embodiments of the invention, and additional embodiments of the invention, will be apparent, and may be made by, persons of ordinary skill in the art having reference to this description. It is contemplated that such changes and additional embodiments are within the spirit and true scope of the invention as claimed below.

We claim:

1. A method for positioning an optical center of an image capturing area of a digital image capturing device, the method comprising:
setting a first reference point on an image sensor of the digital image capturing device;
providing a specific diagram with a marked point displayed on the image sensor;
setting a second reference point projected by the marked point on the image sensor; and
setting the second reference point as the optical center of the image capturing area of the image sensor.

2. The method as recited in claim 1, wherein the step of setting the first reference point on the image sensor further comprises:
setting a first image capturing area on the image sensor, wherein the optical center of the first image capturing area is the geometric center of the image sensor; and
setting any point as the first reference point with a first location relationship which relates to the optical center of the first image capturing area.

3. The method as recited in claim 2, wherein the first location relationship comprises a distance and an angle.

4. The method as recited in claim 2, wherein the first location relationship comprises a horizontal distance and a vertical distance.

5. The method as recited in claim 2, wherein the first location relationship between the first reference point and the first image capturing area is the same as a second location relationship between the specific diagram and the marked point.

6. The method as recited in claim 5, wherein the step of setting a second reference point further comprises the specific diagram is displayed on a second image capturing area of the image sensor.

7. The method as recited in claim 6, wherein the first reference point is set to be the geometric center of the first image capturing area.

8. The method as recited in claim 7, wherein the second reference point is the geometric center of the second image capturing area.

9. The method as recited in claim 1, wherein the image sensor is selected from a charge coupled device (CCD) and a complementary metal-oxide semiconductor.

10. A method for displaying an image of an object on a digital image capturing device, the object locating in front of the digital image capturing device, the method comprising:
providing an image sensor to generate an image on the image sensor;
transforming the image into electronic signals by the image sensor;
setting a first reference point on the image sensor of the digital image capture device;
providing a specific diagram with a marked point displayed on the image sensor;
setting a second reference point projected by the marked point on the image sensor;
recording a position relationship between the first reference point and the second reference point; and
picking up one part of the electronic signals according to the position relationship.

11. The method as recited in claim 10, wherein the step of setting the first reference point on the image sensor further comprises:
setting a first image capture area on the image sensor, wherein the optical center of the first image capture area is the geometric center of the image sensor; and
setting any point as the first reference point with a first location relationship which relates to the optical center of the first image capture area.

12. The method as recited in claim 11, wherein the first location relationship comprises a distance and an angle.

13. The method as recited in claim 11, wherein the first location relationship comprises a horizontal distance and a vertical distance.

14. The method as recited in claim 11, wherein the first location relationship between the first reference point and the first image capturing area is the same as a second location relationship between the specific diagram and the marked point.

15. The method as recited in claim 14, wherein the step of setting a second reference point further comprises the specific diagram is displayed on a second image capturing area of the image sensor.

16. The method as recited in claim 15, wherein the step of picking up one part of the electronic signals is to pick up the part of the electronic signals representing the image on the second image capturing area of the image sensor.

17. The method as recited in claim 10, wherein the positioning relationship between the first reference point and the second reference point comprises a distance and an angle.

18. The method as recited in claim 10, wherein the positioning relationship between the first reference point and the second reference point comprises a horizontal distance and a vertical distance.

19. The method as recited in claim 10, wherein the step of recording the positioning relationship is to save the positioning relationship in a electrical device selected from a group consisting of an image controller, a recording unit, a memory, a signal processor and circuits, inside the digital image capturing device.

20. The method as recited in claim 10, wherein the image sensor is selected from a group consisting of a charge coupled device (CCD) and a complementary metal-oxide semiconductor.

21. A method of image positioning for a digital image capturing device, the method comprising:
providing an image sensor to generate an image displayed on an image display unit;
setting an absolute coordinate on the image display unit;
providing a specific diagram with a marked point displayed on the image display unit; and
setting a reference point, projected by the marked point on the image display unit, as the central point of the image sensor.

22. The method as recited in claim 21, wherein the step of setting the absolute coordinate on the image display unit further comprises:
setting one of four corners of the image display unit as the origin of the absolute coordinate; and
performing the reference point, projected by the marked point, on the image display unit, as the central point of the image sensor.
